(19) United States
(12) Patent Application Publication
(10) Pub. No.: US 2003/0028525 A1
(43) Pub. Date: Feb. 6, 2003

(54) System for and method of determining and using subject matter experts in a forum environment

(76) Inventors: Richard A. Santos, Roseville, CA (US); Paul Anthony Meyers, Granite Bay, CA (US); Jeffrey H. Siegle, Campbell, CA (US)

Correspondence Address: HEWLETT-PACKARID COMPANY, Intellectual Property Administration, P.O. Box 272400, Fort Collins, CO, 80527-2400, US

(21) Appl. No.: 09/921,185

(22) Filed: Aug. 1, 2001

(51) Int. Cl. G06F 7/00; G06F 17/30

(52) U.S. Cl. 707/3

(57) ABSTRACT

The present invention is directed to a system which routes incoming electronic messages or query messages in a forum or bulletin board environment to subject matter experts for resolution. The present invention includes steps or an apparatus for processing information configured to: receive the query message, correlate information contained in the query message with subject matters, route the electronic messages containing correlated data to the subject matter expert and posting query messages on an electronic bulletin board.

### TECHNICAL FIELD

The present invention is directed to information processing and knowledge systems and methods and more specifically for mining questions to and answers from appropriate experts on an Internet or any network and using the mined data to direct future questions.

### BACKGROUND

In the computerized world of today, the exchange of information via e-mail is increasingly common and available. Computer based forums and message and bulletin boards provide an abundance of information on various topics and may be used by individuals to solicit (and provide) information on a variety of topics. Similarly, other services are available on the world wide web (“WWW”) in which individuals can proclaim their expertise in an area and a user can use the WWW to try to identify such “subject matter experts” (SMEs) to address various topics within their respective areas of subject matter expertise. Similarly, within companies self-proclaimed or recognized experts can field technical inquiries within their field of expertise from other employees over the Intranet operated by the company. Examples of these systems include E-HOW, ARZOO, ASK ME, and KEEN.com. However, in each of these examples, the question author must navigate through the system to identify and select the best expert for their needs.

Whether over the Internet or over an intranet within a company, experts can be identified in two known ways. First, a self-proclaimed expert can announce his or her “expertise” in an area and solicit questions within his or her area of expertise. Alternatively, an individual seeking information may post a message requesting help in a specific area. Other users of the Internet (intranet) may read this notice, decide they are able to help the individual looking for an expert, and reply to the inquiry.

Alternatively, questions and answers on a particular topic may be indiscriminately stored in a database and the database may be accessed when an individual has an inquiry of a specific nature within the subject of the database or related topic. For instance, if a database were created to hold all questions and answers related to “storage devices,” an individual who had a question about a storage device may search the database in an attempt to find the answer to their specific question. Failing to find an appropriate answer, the individual may attempt to identify an individual who has answered related questions in order to direct their current question to that individual.

Currently, Tacit Knowledge Systems, Inc. offers “tacit knowledge mail,” in conjunction with a company's intranet to mine information from electronic messages sent by their employees via electronic mail (e-mail). Once these e-mails have been mined for data, the tacit system has the ability to profile an employee based on the information contained in previously sent e-mails. The tacit system then identifies SMEs in specific areas using the profiling information. The tacit system thereafter may provide the names of the SMEs to other system users from keywords which match mined data and are associated with an expert. For example, within a company a specific individual may answer all questions related to storage devices. The tacit system would, upon mining these e-mail messages sent out by the individual, identify the individual as an expert in storage systems or a SME in storage systems. At a later time, when another employee has a question related to storage systems, the tacit system may provide the next employee with the name of the SME by matching names of storage device names extracted from the electronic messages sent by the SME. Procedurally, this matching would occur when the next employee search keywords contained in the tacit system associated with various SMEs, found a match, and received the name of the SME.

### SUMMARY OF THE INVENTION

The present invention is directed to a system and method which processes information queries by receiving a plurality of query messages and identifying areas of subject matter expertise in a first number of the query messages. Each of the query messages within said first number of query messages are correlated with subject matter experts associated with identified areas of subject matter expertise. The first number of query messages are routed to correlated subject matter experts while a second number of the query messages are posted on an electronic bulletin board.

Furthermore, the subject matter expert's knowledge is defined and refined based on a combination of self-proclaimed expertise, the content, and accuracy of the material the SME contributes on an ongoing basis.

### BRIEF DESCRIPTION OF THE DRAWINGS

FIG. 1 illustrates a block diagram of a knowledge system according to one embodiment of the present invention; and

FIG. 2 is a flow diagram detailing a method according to the invention.

### DETAILED DESCRIPTION

The current invention mines, or searches and identifies, data of interest from questions and answers in an Internet forum setting to identify subject matter experts (SMEs) and their respective areas of subject matter expertise. Once identified, forum questions within the identified areas of subject matter expertise of the SME may be sent directly to the expert. Alternatively, the expert may be notified that there is a pending inquiry within their field, or, with the expert's permission, the individual posting the inquiry may be given the electronic address of the expert for use in directing the inquiry directly to the appropriate SME.

In a preferred embodiment the subject matter experts are associated with their subject matter expertise through a database or similar structure. A preferred method of continually refreshing the database includes mining the initial ongoing data from electronic mail (or e-mail) messages sent by individuals, white papers, electronic copies of marketing literature, including attachments to such messages. This preliminary function may be performed using a profiling platform such as the previously described tacit system platform to handle e-mail. That is, as users create and send e-mail, the tacit system platform, which uses that data contained within the e-mail, creates a profile including associate key words. Once the profile is created and contains associated key words, it may be used to identify a SME. The profiling platform then matches the key phrases that are entered (for example product names, product numbers, or description of problems) with the information contained in the profiles that are in their database. If a match is found, the profiling system platform returns a list of “experts” to the user. Note that a profiling platform itself may not accept a question/answer format. Instead, conventional profiling platforms typically required that, once the expert is identified, the user must send an e-mail containing the inquiry to that expert. Thus, once a conventional platform (such as the tacit system) creates profiles from data contained in scanned electronic files or messages, it uses the information collected to identify a SME and provide this identifying information to a request or when appropriate.

The profiling platform may operate as most search engines, by ignoring “stop” words such as “the” and “a”, and focuses on “nonstop” or key words such as product names, problems, model numbers, etc. U.S. Pat. No. 6,253,202 B1, entitled, “Method, System And Apparatus For Authorizing Access By A First User To A Knowledge Profile Of A Second User Responsive To An Access Request From The First User” issued Jun. 26, 2001; U.S. Pat. No. 6,205,472 B1, entitled, “Method And Apparatus For Querying A User Knowledge Profile” issued Mar. 20, 2001; U.S. Pat. No. 6,154,783 entitled“Method And Apparatus For Addressing An Electronic Document For Transmission Over A Network” issued Nov. 28, 2000 and U.S. Pat. No. 6,115,709 entitled “Method And System For Constructing A Knowledge Profile Of A User Having Unrestricted And Restricted Access Portions According To Respective Levels Of Confidence Of Content Of The Portions” issued Sep. 5, 2000 describe the tacit product profiling platform and are hereby incorporated by reference in their entirety.

The tacit profiling platform includes an algorithm that is used to identify and rate probabilities associated with the subject matter of an expert. This algorithm includes the use of frequency of occurrence of the nonstop words and proximity of nonstop words to each other. This information is used to predict a probability associated with receiving an answer regarding the inquiry of the individual. Once the tacit profiling platform identifies the expert to the individual, the functions performed by the platform are considered completed.

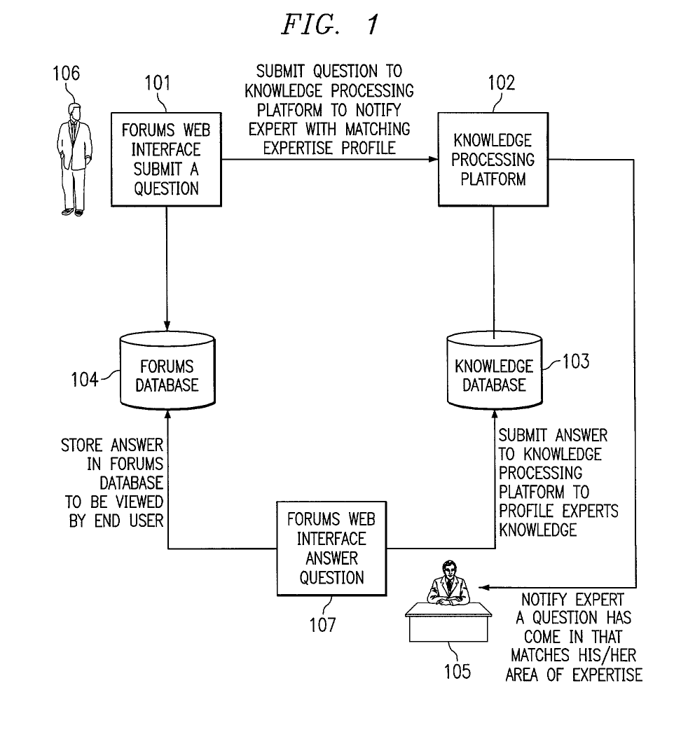

FIG. 1 shows an overall diagram of one embodiment of the invention. A profile is built by the system by monitoring and examining communications between expert 105 and a bulletin board or a forum. Expert 105 may communicate by contributing answers through the forums web interface, 107. Answers contributed by subject matter expert (SME)105 are sent to knowledge database 103 and knowledge processing platform 102, or knowledge product, builds a profile of SME 105 by identifying nonstop (i.e., key) words, frequency and relationship of nonstop words, and their association with SME 105. Expert profiles are then created and stored in knowledge database 103 for later use. When user 106 uses forums web interface 101 to submit a question, a query message, or a number of query messages, the text of the question is “mined” for nonstop words and the identified nonstop words are compared to information stored in knowledge database 103. The question can be of any length, such as one sentence or several paragraphs. The question is sent to knowledge processing platform 102 which identifies the appropriate experts and notifies the experts in that subject matter of the inquiry. This notification may be by routing the question or query message to the expert. The expert, at their discretion, should be able to either enter into a real time discussion with the question author, or respond to the question on the bulletin board at his/her convenience.

When user 106 posts a question, SME 105 is notified of the question when it falls within their area of subject matter expertise. Simultaneously the question posted by user 106 can also be stored in forums database 104 for the broader community to view and possibly respond to. Anyone in the forum community can answer the inquiry but expert 105 has been proactively notified of a specific question that fits their profile that is stored in knowledge database 103.

Forums database 104 also includes a search function so any user may use the search function to review data contained in the database prior to posting a question. Additionally, forums database 104 may be configured to store questions posted by user 106 and answers supplied by SME 105. In this configuration, an additional search may be performed to determine if a responsive answer is already included in forums database 104.

For example, once a database associating SMEs 105 with their subject matter expertise, information queries can be processed in the following manner. User 106 submits one or more query messages using forum web interface 101. Once received the query messages are analyzed by knowledge processing platform 102 to determine if each query message contains references to predetermined or newly and/or dynamically defined areas of subject matter expertise. For query messages which are recognized as containing references to previously identified areas of subject matter expertise a correlation is performed to associate those query messages with the SMEs 105. The query messages containing references to these areas of subject matter expertise are then routed to the appropriate subject matter experts. Additionally, query messages may be posted on the electronic bulletin board.

Messages posted on the electronic bulletin board may consist of all messages, messages which were forwarded to subject matter experts, messages which were not forwarded to subject matter experts, those designated by message submitters, or a combination thereof. The query messages may be questions submitted to a bulletin board or a forum.

In a preferred embodiment an individual is not classified as a SME until they have answered a minimum number of questions within a particular subject matter area. Rating mechanisms may be used in deciding when an individual who has answered questions is included within the database. One rating mechanism which may be used solicits response satisfaction “scores” rating the SME answer by the individual who submitted the original question. In one embodiment each query submitted may score the answers on a scale of 1 to with one being a low rating and 10 being the highest rating. In this embodiment an individual who answers questions may be included in the database after attaining a cumulative score of 250 points. Subject matter experts may also be rated. For example, a “pro” may be a SME with a cumulative score of 250 points; a “graduate” with a score of 500 points; and a “wizard” with a score of 1,000 points. Alternatively, an average score may be used to eliminate subject matter experts with low scores or who fail to provide adequate answers. A SME's expertise will constantly be refined based on their ongoing contribution to the community.

In addition, an individual who has been identified as a potential subject matter expert may be asked to provide information concerning their area of expertise or of areas in which they desire to answer questions.

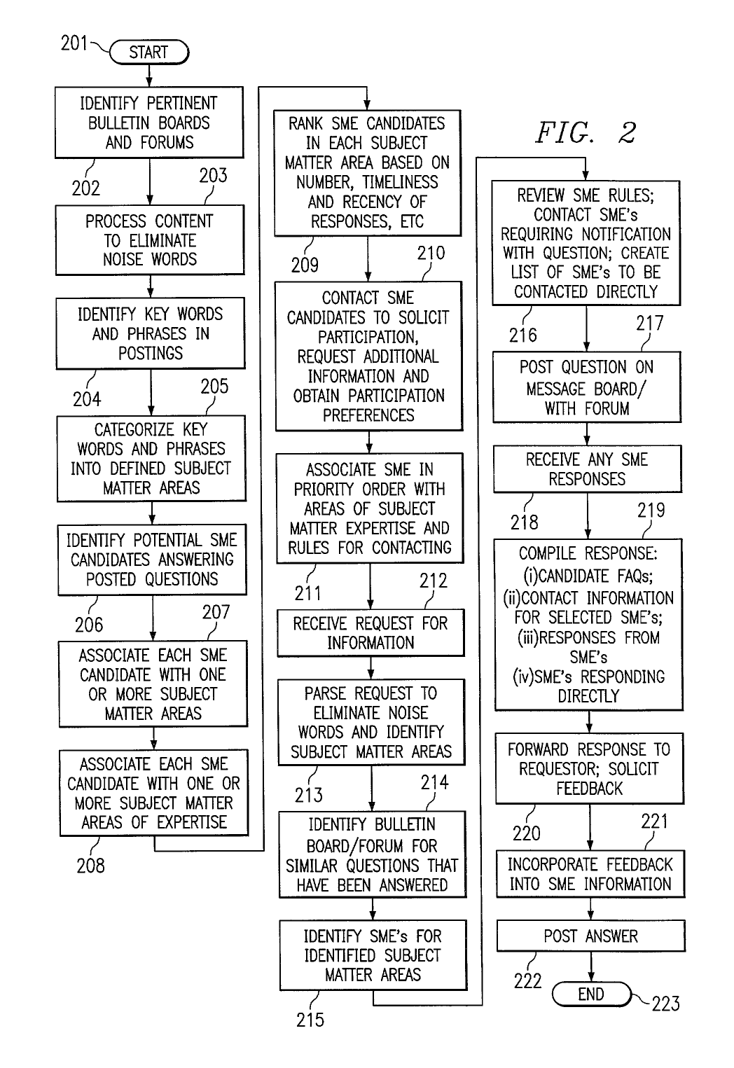

FIG. 2 is a block diagram of a method according to one embodiment of the invention. Entering at step 201, pertinent bulletin boards and forums are identified at step 202. These bulletin boards and forums may include those supported by internal servers on a company-wide Intranet and/or publicly accessible resources available on, for example, the Internet. At step 203, the content of the bulletin boards and forums are processed to eliminate noise words as previously described. Noise words are terms and phrases which are not helpful in identifying the subject matter of a textual document including, for example, the words “the”, “a”, etc. The remaining words and phrases are identified at step 204. Then, at step 205 these key words and phrases are categorized into defined subject matter areas. For example, the terms and phrases including “toner cartridge”, “print engine”, “fuser”, “paper tray”, etc. may all be associated with printers and/or copier machines. Further distinctions may be made using other terminology approximate to such key terms and phrases.

At the same time that the postings are parsed to identify the subject matter areas of the postings, identifying information is collected concerning potential SME candidates, step 206, based on the posted responses to corresponding questions as shown in step 207. At step 208, the SME candidate is associated with one or more subject matter areas of expertise. Depending on the granularity of the categorization effected at step 205, a SME may be associated with several subject matter areas of expertise, each of which may include different qualifications or rankings in association with the SME. Thus, at step 209, the SME candidates are ranked in each subject matter based on a number of criteria including, for example, the number, timeliness and recency of responses identified on the bulletin boards and forums. Evaluations received from individuals posting questions may also be used in ranking SME candidates. In addition, other documents including SME responses to earlier questions may be considered in formulating a list of SME candidates including, for example, electronic articles published by SME, academic and professional qualifications, etc. At step 210 the SME candidates may be contacted to solicit their voluntary or other type of participation at which time additional information may be requested together with participation preferences of the SME candidate. For example, the SME candidate may edit the subject matter areas in which they would agree to respond to questions, limit the number of responses over some period such as over the course of a month, request that their participation remain anonymous by having all communications channeled through the platform, or provide other rules used in contacting the SME. Thus, at step 211, the participating screens are associated, in priority order with areas of subject matter expertise together with rules to be used in contacting the SMEs.

Having built the basic database, a request for information is received at step 212. Instead of merely posting the request in the form of a question on a bulletin board or forum listing, the system, at step 215, parses the request to eliminate noise words and to identify subject matter areas to which the information requested is directed. The associated bulletin board and/or forum is searched at step 214 to identify any similar questions and answers that may be responsive to the information request forming a first part of a response. At step 215, the appropriate SME or SMEs are identified. The rules established for each of the identified SMEs are reviewed at step 216 and implemented. Thus, SMEs requiring that they be notified of the request and forwarded a copy of the question are contacted, while SMEs agreeing to be contacted directly by an information requestor are listed.

A third part of the information process is initiated at step 217 wherein the question is posted on the message board or with the forum. At step 218, SME answers in response to steps 216 and 217 are collected and, at step 219 are compiled together with a list of candidate existing questions/answers (e.g., frequently asked questions (FAQs)) as identified in step 214 and contact information for SMEs listed as a result of step 216. At step 220, the response including some or all of the items compiled in step 219 is forwarded to the requestor. At the same time, the requestor is solicited to provide feedback to be used in rating the SMEs and ranking them. Thus, at step 221, feedback from the requesters are incorporated into the SME information including, for example, the definition of areas in which the SME has particular expertise. According to one implementation, the SME may be given a summary of feedback information and provided with an opportunity to make corrections and/or change his/her participation preferences. At step 222 the various answers received from the SMEs are posted and, at step 223, the process terminates.

What is claimed is:

1. A method of processing information queries comprising the steps of:
receiving a plurality of query messages and identifying areas of subject matter expertise in a first number of said query messages;
correlating each query message within said first number of query messages with subject matter experts associated with identified areas of subject matter expertise;
routing each of said first number of query messages to correlated subject matter experts; and
posting a second number of said query messages on an electronic bulletin board.

2. The method according to claim 1 wherein said second number of query messages includes all of said plurality of query messages.

3. The method according to claim I wherein said second number of query messages includes said plurality of query messages excluding said first number of query messages.

4. The method according to claim 1 wherein said step of correlating includes at least the steps of.
accessing a database associating said subject matter experts with said areas of subject matter expertise; and
matching said query messages with said subject matter experts.

5. The method according to claim 1 further comprising as step of:
updating said database in response to said correlating step.

6. The method according to claim 1 wherein said query messages are questions posted to a bulletin board.

7. The method according to claim 1 further comprising the steps of:
soliciting input from said subject matter experts; and
considering said solicited input from said subject matter experts in determining associations between said subject matter expertise and respective subject matter experts.

8. The method according to claim 1 further comprising the steps of:
analyzing a plurality of electronic documents to identify areas of subject matter expertise associated with respective subject matter experts; and
updating a database associating said subject matter experts with respective ones of said areas of expertise.

9. The method according to claim 1 further comprising the steps of:
receiving a quality measurement; and
using said quality measurement in determining associations between said subject matter expertise and respective subject matter experts.

10. The method according to claim 1 further comprising the step of-. updating a database to include answers to said query messages.

11. The method according to claim 10 further comprising the step of:
searching said database for an answer to said query message.

12. The method according to claim 11 further comprising the step of:
providing said answer in response to said query message.

13. An apparatus for processing information queries comprising:
a communication device configured to receive a plurality of query messages;
a processor configured to identify areas of subject matter expertise in a first number of said query messages and correlate said first number of query messages with subject matter experts associated with said areas of subject matter expertise;
a communications interface configured to route each of said first number of said query messages to correlated subject matter experts; and
an electronic bulletin board configured to post a second number of said query messages.

14. The apparatus for processing information queries according to claim 13 wherein said second number of said query messages includes all of said plurality of query messages.

15. The apparatus for processing information queries according to claim 13 wherein said second number of said query messages includes said plurality of query messages excluding said first number of said query messages.

16. The apparatus for processing information queries according to claim 13 wherein said processor is further configured to access a database associating said subject matter experts with said areas of subject matter expertise, and match said query messages with said subject matter experts.

17. The apparatus for processing information queries according to claim 13 wherein said processor is further configured to update a database associating said subject matter experts with said areas of subject matter expertise.

18. The apparatus for processing information queries according to claim 13 wherein said query messages include questions posted to a bulletin board.

19. The apparatus for processing information queries according to claim 13 wherein said processor is further configured to solicit input from said subject matter experts, and determine associations between said subject matter expertise and respective subject matter experts in response to said solicited input from said subject matter experts.

20. The apparatus for processing information queries according to claim 13 wherein said processor is further configured to analyze a plurality of electronic documents to identify areas of subject matter expertise associated with respective subject matter experts, and update a database associating said subject matter experts with respective ones of said areas of expertise.

21. The apparatus for processing information queries according to claim 13 wherein said processor is further configured to update a database to include answers to said query messages.

22. The apparatus for processing information queries according to claim 13 wherein said processor is further configured to receive a quality measurement, and determine associations between said subject matter expertise and respective subject matter experts in response to said quality measurement.

23. A method of processing information queries comprising the steps of:
receiving a plurality of query messages and identifying areas of subject matter expertise in a first number of said query messages;
correlating each query message within said first number of query messages with subject matter experts associated with identified areas of subject matter expertise;
routing information pertaining to each of said first number of query messages to correlated subject matter experts; and
posting a second number of said query messages on an electronic bulletin board.
